(19) United States
(12) Patent Application Publication
(10) Pub. No.: US 2026/0094160 A1
(43) Pub. Date: Apr. 2, 2026

(54) SYSTEMS AND METHODS FOR TRANSACTION PROCESSING OPTIMIZATION

(71) Applicant: Fiserv, Inc., Milwaukee, WI (US)

(72) Inventors: Steven W. MATHISON, Omaha, NE (US); Vimalkumar BRAHMBHATT, Hillsborough, NJ (US); Mohd AMIR, Far Hills, NJ (US); Ranjit SINGH, Alpharetta, GA (US)

(73) Assignee: Fiserv, Inc., Milwaukee, WI (US)

(21) Appl. No.: 19/341,426

(22) Filed: Sep. 26, 2025

Related U.S. Application Data
(60) Provisional application No. 63/700,021, filed on Sep. 27, 2024.

(51) Int. Cl. G06Q 20/40; G06F 3/04847

(52) U.S. Cl. CPC G06Q 20/4016; G06F 3/04847

(57) ABSTRACT

A method may include receiving merchant input indicating a target level of security and a target level of transaction authorization, determining, based on the merchant input, a set of analytic services to be applied to transactions, the set of analytic services configured to generate data regarding a transaction, in response to receiving transaction data of a transaction associated with the merchant, automatically making API calls to the set of analytic services requesting data regarding the transaction, determining, based on the data regarding the transaction from the set of analytic services and the merchant input, whether to transmit an authorization request, in response to determining to transmit the authorization request, generating the authorization request based on the data regarding the transaction from the set of analytic services and the merchant input, and transmitting the authorization request to an issuer system.

### CROSS-REFERENCE TO RELATED APPLICATIONS

This application claims priority to U.S. Provisional Application No. 63/700,021 titled “SYSTEMS AND METHODS FOR TRANSACTION PROCESSING OPTIMIZATION,” filed September 27, 2024, which application is incorporated herein by reference in its entirety.

### BACKGROUND

Transactions from merchants can be analyzed to identify fraud and to offer recommendations as to whether to authorize the transactions before routing the transactions to an issuer processor for authorization. Various analytic processes or services can affect a cost of the transactions, a fraud risk of the transactions, and an authorization probability of the transactions.

### SUMMARY

Various aspects of the disclosure may now be described with regard to certain examples and embodiments, which are intended to illustrate but not limit the disclosure. Although the examples and embodiments described herein may focus on, for the purpose of illustration, specific systems and processes, one of skill in the art may appreciate the examples are illustrative only, and are not intended to be limiting.

Aspects of the present disclosure are directed to a system including one or more processors and a non-transitory, computer-readable medium including instructions which, when executed by the one or more processors, cause the one or more processors to receive, via a user interface, merchant input indicating a target level of security and a target level of transaction authorization, determine, based on the merchant input, a set of analytic services to be applied to transactions of a merchant providing the merchant input, the set of analytic services configured to indicate approval or rejection of a transaction, in response to receiving transaction data of a transaction associated with the merchant, automatically making one or more API calls to the set of analytic services requesting input regarding approval or rejection of the transaction, and in response to the input from the set of analytic services indicating approval of the transaction, transmitting the transaction data to an issuer processor for approval.

In some implementations, the user interface includes a sliding scale between security and transaction authorization, and wherein the merchant input indicating the target level of security and the target level of transaction authorization includes a selection of a point on the sliding scale. In some implementations, the target level of security includes a first target level of security for a first type of transaction and a second target level of security for a second type of transaction. In some implementations, the instructions further cause the one or more processors to receive additional data associated with the merchant, and wherein the instructions cause the one or more processors to determine the set of analytic services based on the merchant input and the additional data. In some implementations, the additional data includes historical transaction data of the merchant. In some implementations, the additional data includes historical fraud data of the merchant. In some implementations, the instructions further cause the one or more processors to, in response to receiving the transaction data, determine one or more characteristics of the transaction, and based on the one or more characteristics of the transaction, select a subset of the set of analytic services to query using the one or more API calls. In some implementations, the one or more characteristics include one or more of a time of day, a payment medium, the issuer processor, a merchant location, and an identity of a customer associated with the transaction. In some implementations, the instructions further cause the one or more processors to assign weights to the set of analytic services, wherein the input from the set of analytic services indicating approval reflects responses from the set of analytic services, weighted according to their respective weights. In some implementations, the merchant input indicates a target level of transaction cost.

Aspects of the present disclosure are directed to a method including receiving, by one or more processors, via a user interface, merchant input indicating a target level of security and a target level of transaction authorization, determining, by the one or more processors, based on the merchant input, a set of analytic services to be applied to transactions of a merchant providing the merchant input, the set of analytic services configured to indicate approval or rejection of a transaction, in response to receiving transaction data of a transaction associated with the merchant, automatically making one or more API calls, by the one or more processors, to the set of analytic services requesting input regarding approval or rejection of the transaction, and in response to the input from the set of analytic services indicating approval of the transaction, transmitting, by the one or more processors, the transaction data to an issuer processor for approval.

In some implementations, the user interface includes a sliding scale between security and transaction authorization, and wherein the merchant input indicating the target level of security and the target level of transaction authorization includes a selection of a point on the sliding scale. In some implementations, the target level of security includes a first target level of security for a first type of transaction and a second target level of security for a second type of transaction. In some implementations, the method includes receiving, by the one or more processors, additional data associated with the merchant, and wherein determining the set of analytic services is based on the merchant input and the additional data. In some implementations, the additional data includes historical transaction data of the merchant. In some implementations, the additional data includes historical fraud data of the merchant. In some implementations, the method includes, in response to receiving the transaction data, determining, by the one or more processors, one or more characteristics of the transaction, and based on the one or more characteristics of the transaction, selecting, by the one or more processors, a subset of the set of analytic services to query using the one or more API calls. In some implementations, the one or more characteristics include one or more of a time of day, a payment medium, the issuer processor, a merchant location, and an identity of a customer associated with the transaction. In some implementations, the method includes assigning weights to the set of analytic services, wherein the input from the set of analytic services indicating approval reflects responses from the set of analytic services, weighted according to their respective weights. In some implementations, the merchant input indicates a target level of transaction cost.

The foregoing summary is illustrative only and is not intended to be in any way limiting. In addition to the illustrative aspects, embodiments, and features described above, further aspects, embodiments, and features may become apparent by reference to the following drawings and the detailed description.

### BRIEF DESCRIPTION OF THE DRAWINGS

FIG. 1 is an example block diagram of an environment in which transactions are processed.

FIG. 2 is an example block diagram illustrating details of the payment optimization engine of FIG. 1.

FIG. 3 is an example flow diagram of a method for optimizing processing of transactions.

FIG. 4 is an example block diagram of a computing system 400.

The foregoing and other features of the present disclosure may become apparent from the following description and appended claims, taken in conjunction with the accompanying drawings. Understanding that these drawings depict only several embodiments in accordance with the disclosure and are therefore, not to be considered limiting of its scope, the disclosure may be described with additional specificity and detail through use of the accompanying drawings.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It may be readily understood that the aspects of the present disclosure, as generally described herein, and illustrated in the figures, may be arranged, substituted, combined, and designed in a wide variety of different configurations, all of which are explicitly contemplated and made part of this disclosure.

Aspects of the present disclosure relate to a payment optimization engine for optimizing analysis and processing of transactions. Merchants may have different preferences for an amount of risk they are willing to tolerate, a cost per transaction they are willing to pay, and a percentage of transactions that are authorized. Various different analytic services for analyzing transactions for fraud, transaction cost, and authorization can be utilized, but it can be difficult for merchants to navigate the various combinations of analytic services and evaluate how the analytic services serve their needs. The payment optimization engine may allow merchants to input their preferences, such as a balance between risk and transaction authorization, and have transactions automatically routed to analytic services that correspond to their preferences. In this way, the payment optimization engine optimizes use of the analytic services based on the merchant preferences, such that transactions for the merchant are processed according to the merchant’s preferences. The payment optimization engine can adapt use of the analytic services based on transaction characteristics, fraud history, and/or transaction history. Additionally, the payment authorization engine can allow for data to be shared between merchants and issuers to increase transaction authorizations and reduce costs incurred due to chargebacks and fraud.

The payment optimization engine can leverage data concerning transaction authorizations to generate authorization requests. The payment optimization engine can, based on merchant preferences, optimize authorization requests to increase an approval rate. For example, the payment optimization engine can augment or modify authorization requests based on long-term and short-term issuer trends to implement the merchant preferences. In this way, the payment optimization engine can implement the merchant preferences using input from the analytic services, transaction authorization data, and issuer-specific trends. In some implementations, the payment optimization engine generates rules based on transaction authorization data and issuer-specific data at regular intervals. In this way, the payment optimization engine can reduce processing latency by utilizing the pre-generated rules in generating authorization requests instead of analyzing the transaction authorization data and issuer-specific data in real time.

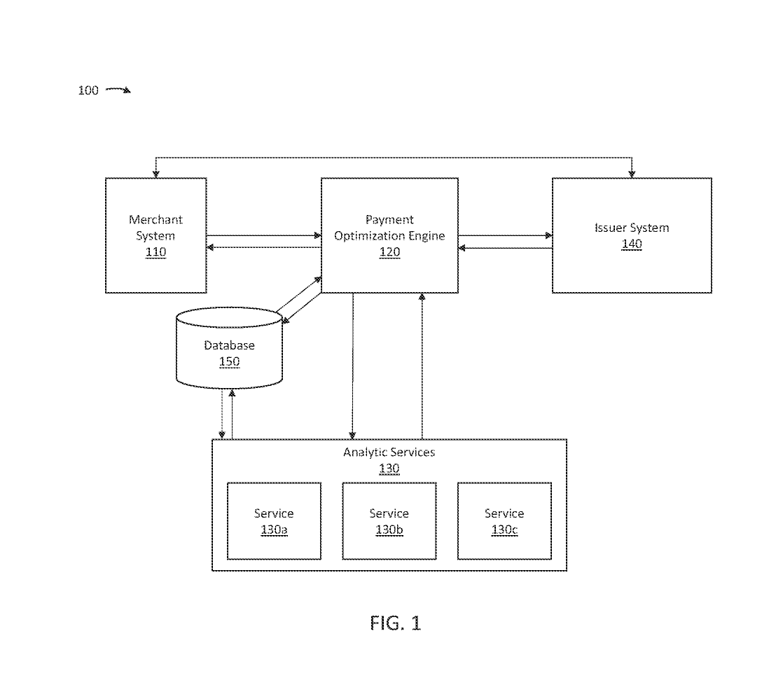

FIG. 1 is an example block diagram of an environment 100 in which transactions are processed. The environment 100 includes a merchant system 110, a payment optimization engine 120, analytic services 130, an issuer system 140, and a database 150.

The merchant system 110 provides merchant input to the payment optimization engine 120. The merchant input may include a target level of security and a target level of transaction authorization. In some implementations, the merchant input include a target cost per transaction. The target level of security, the target level of transaction authorization, and/or the target cost per transaction may be weighted to indicate a relative importance of the target level of security, the target level of transaction authorization, and/or the target cost per transaction. In some implementations, the weighting of the target level of security, the target level of transaction authorization, and/or the target cost per transaction is indicated by providing values for each, where the values indicate their relative importance. In some implementations, the weighting is indicated by specifying a balance between the target level of security, the target level of transaction authorization, and/or the target cost per transaction. In an example, a sliding scale between greater transaction authorization and greater security and/or cost is provided for indicating merchant input. In an example, a merchant indicates a point within a triangle, or another shape, where a position within the shape indicates a preference for security, transaction authorization, and/or cost per transaction. The payment optimization engine 120 may provide one or more user interfaces for providing the merchant input.

The payment optimization engine 120 receives the merchant input from the merchant system 110 and determines, based on the merchant input, a set of analytic services of the analytic services 130 to be applied to transactions received from the merchant system 110. The analytic services 130 include a first service 130a, a second service 130b, and a third service 130c. While three services are illustrated for simplicity, the analytic services 130 may include any number of services. The analytic services 130 may perform different forms of analysis for transactions. The first service 130a may be an authorization optimization service that analyzes transactions to generate a recommendation or score as to whether a transaction should be authorized, to generate a prediction as to whether a transaction will be authorized, and/or to generate a recommendation to increase a chance of the transaction being authorized. The second service 130b may be a fraud service that generates a prediction or score as to a likelihood that a transaction is fraudulent and/or generates alerts for fraudulent transactions. The third service 130c may be a debit routing service that determines a network routing cost or processing cost for a transaction, or which determines a routing for a transaction to minimize its cost to the merchant. One or more of the analytic services 130 may be used to analyze transaction data of a transaction to determine whether the transaction should be authorized, whether a transaction is fraudulent, and/or a cost of the transaction. In an example, all of the analytic services 130 are used to analyze transaction data for a transaction.

The payment optimization engine 120 may weight the outputs of the analytic services 130 (e.g., data regarding the transaction), or the outputs of the set of analytic services used to analyze transactions of the merchant, based on the merchant input. In some implementations, the payment optimization engine 120 determines the set of analytic services along with weights to be applied to the outputs of the analytic services. In an example, the payment optimization engine 120, based on merchant input indicating a preference for increased transaction security over transaction authorization, selects a fraud detection service and a transaction authorization service from the analytic services and weights the fraud detection service with a higher weight and the transaction authorization service with a lower weight such that the outputs of the fraud detection service and the transaction authorization service are weighted to favor greater transaction security over transaction authorization.

The payment optimization engine 120 may determine the set of analytic services of the analytic services 130 to be applied to transactions received by the payment optimization engine 120 from the merchant system 110 based on the merchant input and additional data. The additional data may include historical transaction data of the merchant, historical fraud data of the merchant, merchant characteristics, and other data. In some implementations, the payment optimization engine 120 determines the set of analytic services of the analytic services 130 based one or more historical baselines for transaction authorization, fraud, and/or transaction cost. In an example, the payment optimization engine 120, based on merchant input indicating a preference for greater transaction authorizations over transaction security and a historical fraud baseline for the merchant, determines the set of analytic services to maintain the historical fraud baseline while increasing transaction authorizations. In an example, the payment optimization engine 120, based on merchant input indicating a preference for lower transaction cost over transaction security and a historical fraud baseline for the merchant, determines the set of analytic services to include analytic services that route transactions to lower-cost payment channels or networks.

In some implementations, the merchant input includes different target levels of security and different target levels of transaction authorization for different types of transactions. In some implementations, transactions where a physical transaction card is present have different target levels of security and transaction authorization than card-not-present transactions, such as online transactions. In some implementations, transactions above a predetermined transaction amount threshold have different target levels of security and transaction authorization than transactions below the transaction amount threshold. In an example, card-not-present transactions have a higher target level of security than transactions where a physical transaction card is present. In an example, high-value transactions (above a transaction amount threshold) have a higher target level of security than low-value transactions.

The payment optimization engine 120 may receive transaction data of transactions from the merchant system 110. The payment optimization engine 120 may automatically make one or more API calls (e.g., API calls, webhooks, commands, messages) to the set of analytic services requesting data regarding the transaction. The set of analytic services may each generate a score, recommendation, and/or prediction and provide the requested input to the payment optimization engine 120. The payment optimization engine 120 may determine, based on the data regarding the transaction from the set of analytic services and the merchant input, whether to transmit an authorization request to the issuer system 140. In an example, the set of analytics services may include a fraud service that generates a fraud score indicating a likelihood of fraud for a transaction. The payment optimization engine 120 may compare the fraud score to the merchant input to determine whether the likelihood of fraud for the transaction exceeds an acceptable fraud risk calculated based on the merchant input. In this example, the payment optimization engine 120 can determine to send a denial message to the merchant system 110 and not send an authorization request based on the fraud score being too high.

The payment optimization engine 120, in response to determining to transmit the authorization request, generate the authorization request based on the data regarding the transaction from the set of analytic services and the merchant input. The payment optimization engine 120 may use the transaction data to generate the authorization request. In some implementations, the payment optimization engine 120 selects data from the transaction data to include in the authorization request based on the data regarding the transaction from the set of analytic services and the merchant input.

The database 150 can include transaction data and corresponding approvals or rejections, fraud information, issuer trends, and other information related to transactions. In an example, the database 150 includes information indicating which approvals resulted in fraud chargebacks, which transaction characteristics resulted in approvals and rejections, implementation of new procedures by issuers, and/or approval rates of different payment networks. The payment optimization engine 120 can retrieve data from the database 150 to improve the determination of whether to transmit an authorization request, and to improve the generation of the authorization request.

The payment optimization engine 120 can retrieve data associated with fraud from the database 150 to determine whether to transmit an authorization request. The data associated with fraud can include rates of fraud associated with different transaction characteristics, approved transactions that resulted in fraud chargebacks, changes in rates of fraud, and changes in transaction characteristics associated with fraud. In this way, the payment optimization engine 120 can determine whether to transmit the authorization request based on long-term and short-term fraud trends. The payment optimization engine 120 can use the transaction characteristics, the data regarding the transaction from the set of analytic services, the merchant input, and the data associated with fraud from the database 150 to determine whether to transmit the authorization request. In this way, the payment optimization engine 120 can dynamically react to changes in fraudulent behavior by leveraging the data associated with fraud from the database 150. The payment optimization engine 120 can thus implement the merchant input (e.g., merchant preferences) in response to an evolving payments landscape. In some implementations, the payment optimization engine generates fraud rules based on the data associated with fraud from the database 150 at regular intervals to reduce latency and computational burden for each transaction. In an example, the payment optimization engine 120 generates fraud rules based on the data associated with fraud from the database 150 at a daily interval. In this way, the payment optimization engine 120 can adapt authorization requests to changes in fraud activity while reducing a computational load of each transaction, thus conserving computational resources and reducing latency.

The payment optimization engine 120 can receive information associated with payment routing from the database 150. The information associated with payment routing can include payment network costs as well as approval rates. The approval rates may be based on transaction characteristics. The payment optimization engine 120 can determine an expected cost for each payment network for transactions having different characteristics. The expected cost can be a combination of a cost per transaction as well as a weighted cost representing a cost of rejection (e.g., probability of rejection multiplied by cost of re-sending the transaction on a different payment network). In an example, a first payment network may have a lower cost per transaction than a second payment network, but may have a higher expected cost based on approval rates resulting in higher costs due to rejections. In this example, the payment optimization engine 120 can use the expected cost for each payment network to determine how to implement the merchant input in routing transactions. In this way, the payment optimization engine 120 can optimize cost of transactions based on the merchant input. The payment optimization engine 120 can provide data associated with payment routing to the database 150. The payment optimization engine 120 can provide data indicating which transactions were accepted and rejected by which payment networks, allowing the database 150 to update the information associated with payment routing with updated data.

The payment optimization engine 120 can receive information associated with payment authorizations from the database 150. The information associated with payment authorizations can include approval rates for different issuers. The information associated with payment routing can include adjustments to the approval rates for the issuers based on prevailing influences on approval rates. In an example, different payment networks have different demographics associated with different approval rates and different types of payment instruments (e.g., credit, debit, prepaid) are associated with different approval rates, causing approval rates for issuers to be skewed based on types of transactions they process. By adjusting the approval rates for issuers, the payment optimization engine 120 can more accurately determine an expected approval rate or expected approval for a transaction.

The information associated with payment authorizations can include issuer preferences and trends. In some implementations, the information associated with payment authorizations can indicate approval rates for issuers associated with different transaction characteristics. In an example, a first issuer has a higher approval rate for transactions including tokens instead of PANs, and a second issuer has a higher approval rate for transactions including PANs instead of tokens. In this example, the payment optimization engine 120 can generate authorization requests to the first and second issuers to include the data that leads to higher approval rates. In another example, the payment optimization engine 120 can add information missing from the transaction data, such as an indication of a merchant-initiated transaction in transaction data indicating that the transaction is a scheduled transaction, improving a probability of issuer approval. In this way, the payment optimization engine 120 can implement the merchant input based on the information from the database 150. The payment optimization engine 120 can generate issuer rules at regular intervals. In an example, the payment optimization engine 120 can generate long-term and short-term issuer rules reflecting long-term and short-term approval trends on a daily basis. In an example, an issuer can have a long-term bias towards approving transactions that include tokens instead of PANs, but a short-term bias towards approving transactions that include PANs instead of tokens. In this example, a rule for the issuer can be generated to reflect the short-term bias. In this way, the payment optimization engine 120 can adapt to changes in issuer activity. By generating rules at regular intervals and applying the rules when generating authorization requests, the payment optimization engine 120 can adapt authorization requests to issuer activity while reducing latency.

The information associated with payment authorizations can include merchant and issuer uptake of new procedures. In an example, new data points included in transaction data may be implemented by merchants and issuers at different times. Issuers can have different responses to the new data points, affecting their approval rates for transactions including the new data points. The payment optimization engine 120 can, based on the information associated with payment authorizations, determine whether to include the new data points in authorization requests to the issuer system 140. In this way, the payment optimization engine 120 can adapt the authorization requests based on merchant and issuer uptake of the new data points. As discussed herein, the payment optimization engine 120 can generate rules at regular intervals based on the information associated with payment authorizations. In an example, the payment optimization engine 120 updates merchant and issuer uptake of new procedures and/or data points at a daily interval. In this way, the payment optimization engine 120 can adapt to merchant and issuer activity while reducing latency associated with checking merchant and issuer activity in real time.

For transactions received from the merchant system 110, the payment optimization engine 120 implements the merchant inputs, where the specific implementation of the merchant inputs is based on the data regarding the transaction generated by the set of analytic services, the data from the database 150, and/or rules generated using the data from the database 150. In this way, the payment optimization engine 120 can dynamically translate the merchant input into actions (e.g., adjustment of authorization request, routing through payment networks, rejection of fraudulent transaction) based on the evolving landscape of merchant activity, issuer activity, and customer activity.

In some implementations, the payment optimization engine 120 includes one or more machine-learning models that are trained to determine whether to transmit authorization requests and/or generate authorization requests to implement merchant inputs. The one or more machine-learning models can be updated to reduce a loss between transaction outcomes (e.g., approval denial, fraud chargeback) and merchant inputs or preferences. In this way, the one or more machine-learning models can learn to implement actions that reflect the merchant input.

The payment optimization engine 120 transmits the transaction (i.e., authorization request) to the issuer system 140 for approval. The payment optimization engine 120 may transmit the input from the set of analytic services to the issuer system 140 to inform the approval or rejection of the transaction by the issuer system 140. By including input from the set of analytic services determined based on the merchant input, the approval or rejection of the transaction by the issuer system 140 is informed according to the merchant input. In an example, merchant input prioritizing transaction security may cause the payment optimization engine 120 to provide fraud scores generated by one or more of the analytic services to the issuer system 140 to inform the approval or rejection of transactions by the issuer system 140. In an example, merchant input prioritizing authorization approval may cause the payment optimization engine 120 to provide approval scores generated by one or more of the analytic services to the issuer system 140 to inform the approval or rejection of transactions by the issuer system 140.

In some implementations, the payment optimization engine 120 determines, based on transaction data of a transaction received from the merchant system, one or more characteristics of the transaction. The one or more transaction characteristics may include a time of day, a payment medium, a transaction amount, an identity of the issuer system 140, a merchant location, and/or an identity of a customer associated with the transaction. The payment optimization engine 120 may, based on the one or more transaction characteristics, select a subset of the set of analytic services to query, using the one or more API calls. In some implementations, the payment optimization engine 120 may, based on the one or more transaction characteristics, adjust the weights applied to the set of analytic services. In this way, the payment optimization engine 120 can dynamically adjust the input from the set of analytic services based on the transaction characteristics.

In some implementations, the issuer system 140 and the merchant system 110 can provide data to the payment optimization engine 120 to update and improve the payment optimization engine 120. The data can be used to increase authorizations and reduce fraud. In an example, the payment optimization engine 120 can call the set of analytic services to generate a recommendation on whether to authorize a transaction and a fraud prediction for the transaction. In this example, the issuer system 140 approves the transaction and the merchant system 110 completes the transaction. In this example, the transaction is later determined to be fraudulent (e.g., a user indicates that the transaction was fraudulent), and the issuer system 140 and/or the merchant system 110 indicates to the payment optimization engine 120 that the transaction was fraudulent. The payment optimization engine 120 and/or the analytic services 130 may be updated based on the indication that the transaction was fraudulent. In this way, the merchant system 110 and/or the issuer system 140 can provide incremental data to the payment optimization engine 120 to update and improve the payment optimization engine.

In some implementations, the merchant system 110 and the issuer system 140 can exchange data regarding transactions to improve transaction authorization rates and reduce fraud. The issuer system 140 can provide information to the merchant system 110 regarding whether transactions were approved or denied, and reasons for the approval or rejection. In an example, the issuer system 140 can indicate to the merchant system 110 that a transaction was denied due to insufficient funds. The merchant system 110 can provide information to the issuer system 140 regarding transaction information such as items sold, number of items, and other information. In an example, the merchant system 110, in response to a transaction being determined to be fraudulent, can share what items were purchased with the issuer system 140 such that both the merchant system 110 and the issuer system 140 can better identify fraudulent transactions.

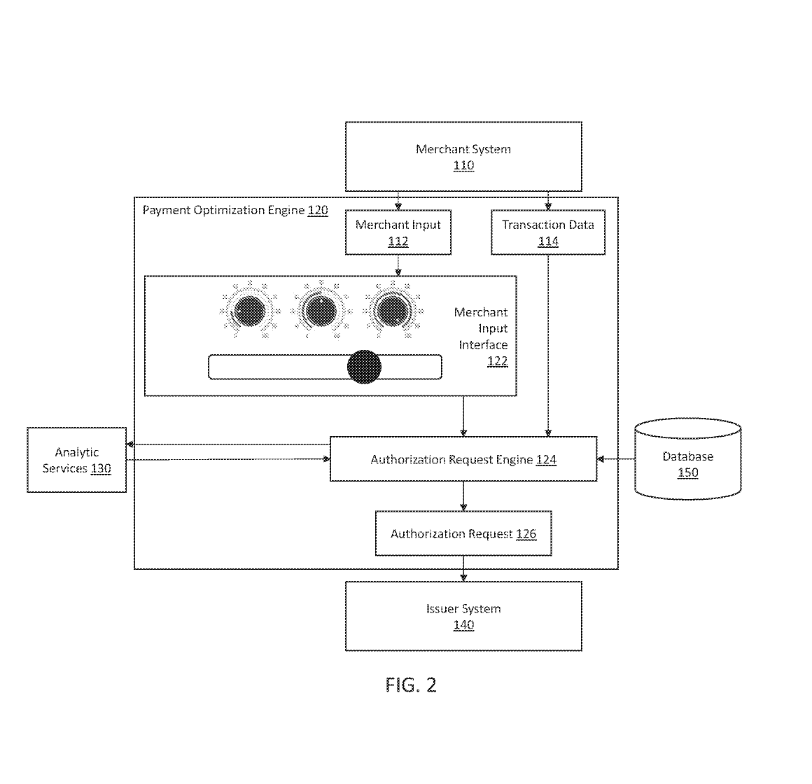

FIG. 2 is an example block diagram illustrating details of the payment optimization engine of FIG. 1. The payment optimization engine 120 may include a merchant input interface 122 for receiving the merchant input 112 from the merchant system 110. The merchant input interface 122 may include various different input mechanisms and/or functions. In an example, the merchant input interface 122 includes dials for indicating a relative importance of different parameters. In an example, a first dial indicates a relative importance of transaction authorization rates, a second dial indicates a relative importance of fraud prevention or transaction security, and a third dial indicates a relative importance of transaction cost. The payment optimization engine 120, as discussed herein, determines the set of analytic services based on the relative importance of transaction authorization rates, fraud prevention, and transaction cost such that the outputs of the set of analytic services reflect the merchant input 112. In some implementations, the merchant input interface 122 includes a sliding scale for indicating a balance between two goals, such as fraud prevention and transaction authorization rate. The merchant input interface 122 may include any type of input mechanism for receiving the merchant input 112. In an example, the merchant input interface 122 includes a survey with questions for determining merchant preferences and goals.

The merchant input interface 122 can provide the merchant input to an authorization request engine 124. The authorization request engine 124 can generate a mapping of preferences to analytic services and/or a list of analytic services based on the merchant input 112. The authorization request engine 124 may map the relative importance of different parameters received via the merchant input interface 122. The authorization request engine 124 may apply one or more weights to the analytic services 130, or to the outputs of the analytic services 130 based on the merchant input 112. The authorization request engine 124 may generate a list of analytic services corresponding to the set of analytic services to be applied to transactions of the merchant. The list of analytic services may include weights for weighting the outputs of the set of analytic services. The authorization request engine 124 can automatically make a set of API calls to the set of analytic services based on the list of analytic services.

The merchant system 110 provides transaction data 114 of a transaction to the payment optimization engine 120. The authorization request engine 124 receives the transaction data 114 and automatically makes a set of API calls (e.g., API calls, webhooks, etc.) to the set of analytic services based on the transaction data 114. The authorization request engine 124 can determine transaction characteristics of the transaction from the transaction data 114 to make the set of API calls. The authorization request engine 124 receives data regarding the transaction from the set of analytic services such as fraud scores, expected costs for payment networks, recommendations for information to be sent to the issuer system 140, and other data. The authorization request engine 124 uses the transaction data 114, the data regarding the transaction from the set of analytic services, and data from the database 150 to determine whether to transmit an authorization request 126. In response to determining to not transmit the authorization request 126, the authorization request engine 124 can generate a denial message to the merchant system 110. In response to determining to transmit the authorization request 126, the authorization request engine 124 can generate the authorization request 126 based on the transaction data 114, the data regarding the transaction from the set of analytic services, and the data from the database 150. As discussed herein, the authorization request engine 124 can generate the authorization request 126 based on long-term and short-term trends in merchant activity, issuer activity, and/or fraud activity. The authorization request engine 124 can generate rules based on the data from the database 150 at regular intervals to reduce a latency in generating the authorization request 126. The payment optimization engine 120 can transmit the authorization request 126 to the issuer system 140.

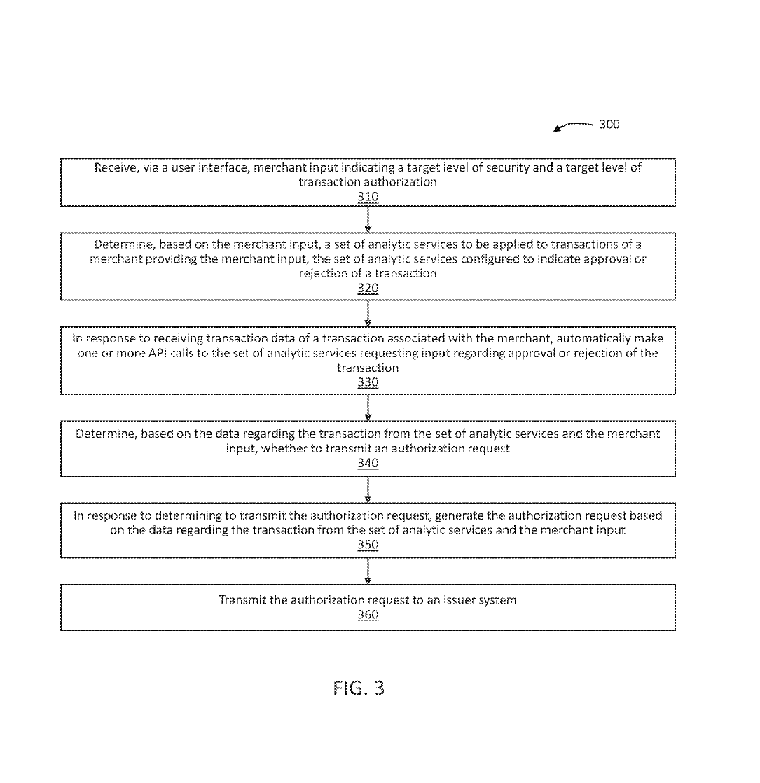

FIG. 3 is an example flow diagram of a method 300 for optimizing processing of transactions. The method 300 may be performed by the payment optimization engine 120 of FIG. 1. The method 300 may include more, fewer, or different operations than shown. The operations may be performed in the order shown, in a different order, or concurrently.

At operation 310, a merchant input is received, via a user interface, the merchant input indicating a target level of security and a target level of transaction authorization. An example of the user interface is the merchant input interface 122 of FIG. 2. In some implementations, the user interface includes a sliding scale between security and transaction authorization, and wherein the merchant input indicating the target level of security and the target level of transaction authorization includes a selection of a point on the sliding scale. In some implementations, the user interface includes dials for indicating the relative importance of security, transaction authorization, and transaction cost.

In some implementations, the target level of security includes a first target level of security for a first type of transaction and a second target level of security for a second type of transaction. In this way, the merchant can specify different target levels of security for different types of transactions. In an example, card-not-present transactions are associated with a higher target level of security. In an example, first purchases made by a new customer are associated with a higher target level of security. In an example, purchases made by customers from an unexpected geography or zip code are associated with a higher target level of security.

In some implementations, the method includes receiving additional data associated with the merchant. The additional data can include historical transaction data of the merchant. The additional data can include historical fraud data of the merchant. Determining the set of analytic services can be based on the merchant input and the additional data associated with the merchant. The historical transaction data and/or the historical fraud data of the merchant can be used to prevent rapid changes in authorization rates for the merchant. The historical transaction data and/or the historical fraud data of the merchant can be used to identify patterns of legitimate and fraudulent transactions at the merchant. The historical transaction data and/or the historical fraud data of the merchant can be used to determine characteristics of legitimate and fraudulent transactions at the merchant.

At operation 320, a set of analytic services are determined based on the merchant input, the set of analytic services to be applied to transactions of a merchant providing the merchant input. The set of analytic services are configured to indicate approval or rejection of a transaction. The set of analytic services may each generate a score indicating a recommendation to approve a transaction, or a score indicating a likelihood that a transaction is fraudulent.

At operation 330, in response to receiving transaction data of a transaction associated with the merchant, one or more API calls are automatically made to the set of analytic services requesting input regarding approval or rejection of the transaction. The set of analytic services may generate their respective recommendations and scores for approving or rejecting the transaction.

In some implementations, the method 300 includes, in response to receiving the transaction data, determining one or more characteristics of the transaction and, based on the one or more characteristics of the transaction, selecting a subset of the set of analytic services to query using the one or more API calls. In some implementations, the one or more characteristics of the transaction include one or more of a time of day, a payment medium, the issuer processor, a merchant location, and an identity of a customer associated with the transaction.

At operation 340, a determination is made whether to transmit an authorization request based on the data regarding the transaction from the set of analytic services and the merchant input. In an example, the data regarding the transaction from the set of analytic services includes a fraud score and the merchant input includes an indication of a risk tolerance, where the determination as to whether to transmit the authorization request compares the fraud score to the risk tolerance of the merchant.

At operation 350, in response to determining to transmit the authorization request, the authorization request is generated based on the data regarding the transaction from the set of analytic services and the merchant input. In some implementations, the authorization request is generated based on the additional data associated with the merchant. In some implementations, the one or more characteristics of the issuer system are determined, such as approval rates for various transaction characteristics. The authorization request can be generated based on the data regarding the transaction from the set of analytic services, the merchant input, and the one or more characteristics of the issuer system. In some implementations, the authorization request is generated based on data on long-term and short-term issuer activity, merchant activity, and/or fraud activity. In some implementations, rules are generated at regular intervals that reflect the long-term and short-term issuer activity, merchant activity, and/or fraud activity. The authorization request can be generated based on the rules to reduce per-transaction latency.

In some implementations, the authorization request can be generated by a machine-learning model that is trained to generate authorization requests to implement merchant preferences. The machine-learning model can be trained to reduce a loss between transaction outcomes and merchant preferences. The machine-learning model can be executed using as input the transaction data, the data regarding the transaction from the analytic services, and short-term and long-term data on merchant activity, issuer activity, and fraud activity to generate authorization requests.

At operation 360, the authorization request is transmitted to an issuer processor for approval. The issuer processor can determine whether to approve or reject the transaction. In some implementations, the issuer processor determines whether sufficient funds are available for the transaction. In some implementations, the input from the set of analytic services is provided to the issuer processor to inform the issuer processors approval or rejection of the transaction. The issuer processor can complete settlement of the transaction using conventional methods. An approval message can be received from the issuer processor and transmitted to the merchant to complete the transaction.

In some implementations, the transaction, in response to the input from the set of analytic services indicating rejection of the transaction, the transaction data is not transmitted to the issuer processor for approval, reducing network usage and decreasing a latency for rejected transactions. A rejection message may be sent to the merchant indicating that the transaction was rejected.

In some implementations, the method 300 includes assigning weights to the set of analytic services. The input from the set of analytic services indicating approval can reflect responses from the set of analytic services, weighted according to their assigned weights. The weights may indicate the relative importance of the output (e.g., scores or recommendations) of the set of analytic services. In this way, the outputs of the analytic services can be modified to reflect the relative importance of factors indicated in the merchant input.

In some implementations, the merchant input indicates a target level of transaction cost. The target level of transaction cost, or relative importance of transaction cost may be used in determining the set of analytic services and/or in determining the weights applied to the outputs of the set of analytic services. The target level of transaction cost may be used to select one or more analytic services that determine cost-efficient transaction routing for transactions. In an example, the set of analytic services recommends approving or rejecting a transaction as well as a payment network for processing the transaction.

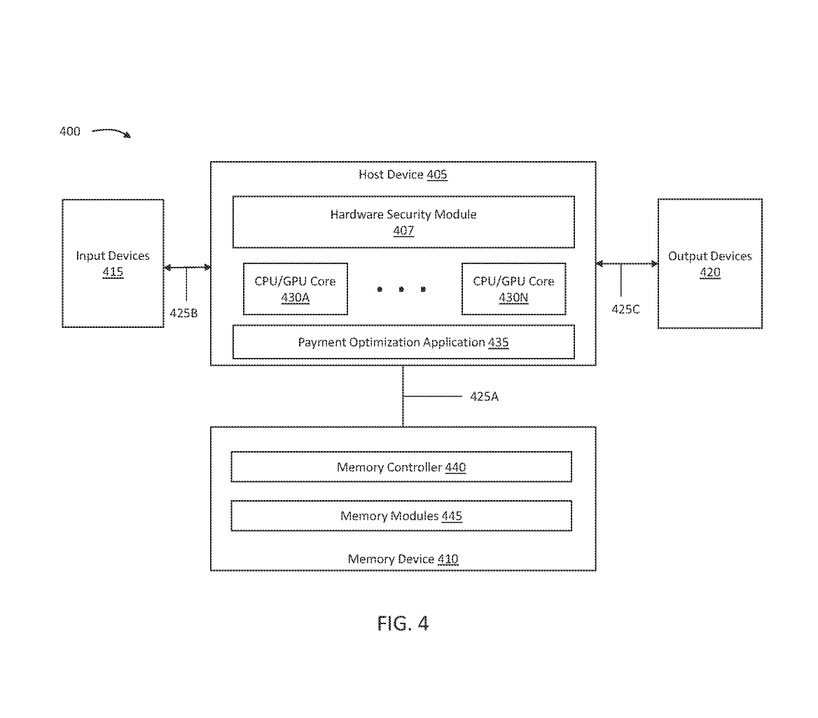

FIG. 4 is an example block diagram of a computing system 400, in accordance with some embodiments of the present disclosure. The computing system 400 includes a host device 405 associated with a memory device 410. The host device 405 may be configured to receive input from one or more input devices 415 and provide output to one or more output devices 420. The host device 405 may be configured to communicate with the memory device 410, the input devices 415, and the output devices 420 via appropriate interfaces or channels 425A, 425B, and 425C, respectively. The computing system 400 may be implemented in a variety of computing devices such as computers (e.g., desktop, laptop, etc.), tablets, personal digital assistants, mobile devices, wearable computing devices such as smart watches, other handheld or portable devices, or any other computing unit suitable for performing operations described herein using the host device 405.

Further, some or all of the features described in the present disclosure may be implemented on a client device, a server device, or a cloud/distributed computing environment, or a combination thereof. Additionally, unless otherwise indicated, functions described herein as being performed by a computing device (e.g., the computing system 400) may be implemented by multiple computing devices in a distributed environment, and vice versa.

The input devices 415 may include any of a variety of input technologies such as a keyboard, stylus, touch screen, mouse, track ball, keypad, microphone, voice recognition, motion recognition, remote controllers, input ports, one or more buttons, dials, joysticks, and any other input peripheral that is associated with the host device 405 and that allows an external source, such as a user, computer, or database, to enter information (e.g., data) into the host device and send instructions to the host device 405. Similarly, the output devices 420 may include a variety of output technologies such as external memories, databases, printers, speakers, displays, microphones, light emitting diodes, headphones, plotters, speech generating devices, video devices, and any other output peripherals that are configured to receive information (e.g., data) from the host device 405. The “data” that is either input into the host device 405 and/or output from the host device may include any of a variety of textual data, graphical data, video data, sound data, position data, combinations thereof, or other types of analog and/or digital data that is suitable for processing using the computing system 400.

The host device 405 may include one or more Central Processing Unit (“CPU”) or Graphics Processing Unit (“GPU”) cores or processors 430A-430N that may be configured to execute instructions for running one or more applications associated with the host device 405. In some embodiments, the instructions and data needed to run the one or more applications may be stored within the memory device 410. The host device 405 may also be configured to store the results of running the one or more applications within the memory device 410. One such application on the host device 405 may include a Payment optimization application 435. The Payment optimization application 435 may be executed by one or more of the CPU/GPU cores 430A-430N. The instructions to execute the Payment optimization application 435 may be stored within the memory device 410. The Payment optimization application 435 is described in greater detail above and may perform functions such as described in FIGS. 1-3 and/or methods such as the method 300 of FIG. 3. Thus, the host device 405 may be configured to request the memory device 410 to perform a variety of operations. For example, the host device 405 may request the memory device 410 to read data, write data, update or delete data, and/or perform management or other operations.

The host device 405 may include a hardware security module 407. The hardware security module 407 may be a physical device (hardware) which performs encryption and decryption functions. The hardware security module 407 may be used by the host device 405 to generate cryptographic keys, encrypt messages, and/or decrypt messages for communicating with merchant systems and issuer systems.

To facilitate communication with the memory device 410, the memory device 410 may include or be associated with a memory controller 440. Although the memory controller 440 is shown as being part of the memory device 410, in some embodiments, the memory controller 440 may instead be part of the host device 405 or another element of the computing system 400 and operatively associated with the memory device 410. The memory controller 440 may be configured as a logical block or circuitry that receives instructions from the host device 405 and performs operations in accordance with those instructions. For example, when the execution of the Payment optimization application 435 is desired, the host device 405 may send a request to the memory controller 440. The memory controller 440 may read the instructions associated with the Payment optimization application 435 that are stored within the memory device 410, and send those instructions back to the host device. In some embodiments, those instructions may be temporarily stored within a memory on the host device 405. One or more of the CPU/GPU cores 430A-430N may then execute those instructions by performing one or more operations called for by those instructions of the Payment optimization application 435.

The memory device 410 may include one or more memory circuits 445 that store data and instructions. The memory circuits 445 may be any of a variety of memory types, including a variety of volatile memories, non-volatile memories, or a combination thereof. For example, in some embodiments, one or more of the memory circuits 445 or portions thereof may include NAND flash memory cores. In other embodiments, one or more of the memory circuits 445 or portions thereof may include NOR flash memory cores, Static Random Access Memory (SRAM) cores, Dynamic Random Access Memory (DRAM) cores, Magnetoresistive Random Access Memory (MRAM) cores, Phase Change Memory (PCM) cores, Resistive Random Access Memory (ReRAM) cores, 3D XPoint memory cores, ferroelectric random-access memory (FeRAM) cores, and other types of memory cores that are suitable for use within the memory device 410. In some embodiments, one or more of the memory circuits 445 or portions thereof may be configured as other types of storage class memory (“SCM”). Generally speaking, the memory circuits 445 may include any of a variety of Random Access Memory (RAM), Read-Only Memory (ROM), Programmable ROM (PROM), Erasable PROM (EPROM), Electrically EPROM (EEPROM), hard disk drives, flash drives, memory tapes, cloud memory, or any combination of primary and/or secondary memory that is suitable for performing the operations described herein.

It is to be understood that only some components of the computing system 400 are shown and described in FIG. 4. However, the computing system 400 may include other components such as various batteries and power sources, networking interfaces, routers, switches, external memory systems, controllers, etc. Generally speaking, the computing system 400 may include any of a variety of hardware, software, and/or firmware components that are needed or considered desirable in performing the functions described herein. Similarly, the host device 405, the input devices 415, the output devices 420, and the memory device 410, including the memory controller 440 and the memory circuits 445, may include hardware, software, and/or firmware components that are considered necessary or desirable in performing the functions described herein. In addition, in certain embodiments, the memory device 410 may integrate some or all of the components of the host device 405, including, for example, the CPU/GPU cores 430A-430N, and the CPU/GPU cores may be configured to execute the Payment optimization application 435, as described herein.

The various illustrative logical blocks, circuits, modules, routines, and algorithm steps described in connection with the embodiments disclosed herein can be implemented as electronic hardware, or combinations of electronic hardware and computer software. To clearly illustrate this interchangeability, various illustrative components, blocks, modules, and steps have been described above generally in terms of their functionality. Whether such functionality is implemented as hardware, or as software that runs on hardware, depends upon the particular application and design constraints imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a general purpose processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A control processor can synthesize a model for an FPGA. For example, the control processor can synthesize a model for logical programmable gates to implement a tensor array and/or a pixel array. The control channel can synthesize a model to connect the tensor array and/or pixel array on an FPGA, a reconfigurable chip and/or die, and/or the like. A general purpose processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, "can," "could," "might," "may," “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively "associated" such that the desired functionality is achieved. Hence, any two components herein combined to achieve a particular functionality can be seen as "associated with" each other such that the desired functionality is achieved, irrespective of architectures or intermedial components. Likewise, any two components so associated can also be viewed as being "operably connected," or "operably coupled," to each other to achieve the desired functionality, and any two components capable of being so associated can also be viewed as being "operably couplable," to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as "open" terms (e.g., the term "including" should be interpreted as "including but not limited to," the term "having" should be interpreted as "having at least," the term "includes" should be interpreted as "includes but is not limited to," etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases "at least one" and "one or more" to introduce claim recitations. However, the use of such phrases should not be construed to imply that the introduction of a claim recitation by the indefinite articles "a" or "an" limits any particular claim containing such introduced claim recitation to inventions containing only one such recitation, even when the same claim includes the introductory phrases "one or more" or "at least one" and indefinite articles such as "a" or "an" (e.g., "a" and/or "an" should typically be interpreted to mean "at least one" or "one or more"); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of "two recitations," without other modifiers, typically means at least two recitations, or two or more recitations). Furthermore, in those instances where a convention analogous to "at least one of A, B, and C, etc." is used, in general such a construction is intended in the sense one having skill in the art would understand the convention (e.g., "a system having at least one of A, B, and C" would include but not be limited to systems that have A alone, B alone, C alone, A and B together, A and C together, B and C together, and/or A, B, and C together, etc.). In those instances, where a convention analogous to "at least one of A, B, or C, etc." is used, in general such a construction is intended in the sense one having skill in the art would understand the convention (e.g., "a system having at least one of A, B, or C" would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase "A or B" will be understood to include the possibilities of "A" or "B" or "A and B." Further, unless otherwise noted, the use of the words “approximate,” “about,” “around,” “substantially,” etc., mean plus or minus ten percent.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. A system comprising:
one or more processors; and
a non-transitory, computer-readable medium including instructions which, when executed by the one or more processors, cause the one or more processors to:
receive, via a user interface, merchant input indicating a target level of security and a target level of transaction authorization;
determine, based on the merchant input, a set of analytic services to be applied to transactions of a merchant providing the merchant input, the set of analytic services configured to generate data regarding a transaction;
in response to receiving transaction data of a transaction associated with the merchant, automatically making one or more API calls to the set of analytic services requesting data regarding the transaction;
determine, based on the data regarding the transaction from the set of analytic services and the merchant input, whether to transmit an authorization request;
in response to determining to transmit the authorization request, generate the authorization request based on the data regarding the transaction from the set of analytic services and the merchant input; and
transmit the authorization request to an issuer system.

2. The system of claim 1, wherein the user interface includes a sliding scale between security and transaction authorization, and wherein the merchant input indicating the target level of security and the target level of transaction authorization includes a selection of a point on the sliding scale.

3. The system of claim 1, wherein the target level of security includes a first target level of security for a first type of transaction and a second target level of security for a second type of transaction.

4. The system of claim 1, wherein the instructions further cause the one or more processors to:
receive additional data associated with the merchant; and
determine the set of analytic services based on the merchant input and the additional data.

5. The system of claim 4, wherein the additional data includes one or more of historical transaction data of the merchant and historical fraud data of the merchant.

6. The system of claim 4, wherein the instructions further cause the one or more processors to generate the authorization request based on the additional data associated with the merchant.

7. The system of claim 1, wherein the instructions further cause the one or more processors to:
in response to receiving the transaction data, determine one or more characteristics of the transaction; and
based on the one or more characteristics of the transaction, select a subset of the set of analytic services to query using the one or more API calls.

8. The system of claim 7, wherein the one or more characteristics include one or more of a time of day, a payment medium, the issuer system, a merchant location, and an identity of a customer associated with the transaction.

9. The system of claim 1, wherein the instructions further cause the one or more processors to assign weights to the set of analytic services, wherein the data regarding the transaction reflects responses from the set of analytic services, weighted according to their assigned weights.

10. The system of claim 1, wherein the instructions further cause the one or more processors to:
determine one or more characteristics of the issuer system; and
generate the authorization request based on the data regarding the transaction from the set of analytic services, the merchant input, and the one or more characteristics of the issuer system.

11. A method comprising:
receiving, by one or more processors, via a user interface, merchant input indicating a target level of security and a target level of transaction authorization;
determining, by the one or more processors, based on the merchant input, a set of analytic services to be applied to transactions of a merchant providing the merchant input, the set of analytic services configured to generate data regarding a transaction;
in response to receiving transaction data of a transaction associated with the merchant, automatically making, by the one or more processors, one or more API calls to the set of analytic services requesting data regarding the transaction;
determining, by the one or more processors, based on the data regarding the transaction from the set of analytic services and the merchant input, whether to transmit an authorization request;
in response to determining to transmit the authorization request, generating, by the one or more processors, the authorization request based on the data regarding the transaction from the set of analytic services and the merchant input; and
transmitting, by the one or more processors, the authorization request to an issuer system.

12. The method of claim 11, wherein the user interface includes a sliding scale between security and transaction authorization, and wherein the merchant input indicating the target level of security and the target level of transaction authorization includes a selection of a point on the sliding scale.

13. The method of claim 11, wherein the target level of security includes a first target level of security for a first type of transaction and a second target level of security for a second type of transaction.

14. The method of claim 11, further comprising:
receiving, by the one or more processors, additional data associated with the merchant; and
determining, by the one or more processors, the set of analytic services based on the merchant input and the additional data.

15. The method of claim 14, wherein the additional data includes one or more of historical transaction data of the merchant and historical fraud data of the merchant.

16. The method of claim 14, further comprising generating, by the one or more processors, the authorization request based on the additional data associated with the merchant.

17. The method of claim 11, further comprising:
in response to receiving the transaction data, determining, by the one or more processors, one or more characteristics of the transaction; and
based on the one or more characteristics of the transaction, selecting, by the one or more processors, a subset of the set of analytic services to query using the one or more API calls.

18. The method of claim 17, wherein the one or more characteristics include one or more of a time of day, a payment medium, the issuer system, a merchant location, and an identity of a customer associated with the transaction.

19. The method of claim 11, further comprising assigning, by the one or more processors, weights to the set of analytic services, wherein the data regarding the transaction reflects responses from the set of analytic services, weighted according to their assigned weights.

20. The method of claim 11, further comprising:
determining, by the one or more processors, one or more characteristics of the issuer system; and
generating, by the one or more processors, the authorization request based on the data regarding the transaction from the set of analytic services, the merchant input, and the one or more characteristics of the issuer system.
